(19) United States
(12) Patent Application Publication
(10) Pub. No.: US 2010/0018597 A1
(43) Pub. Date: Jan. 28, 2010

(54) PRESSURE RELIEF VALVE STRUCTURE WITH PRESSURE RELIEF SEAM

(76) Inventors: HSI-MING SHU, Taipei (TW); Tsang-Ming Chang, Taipei (TW); Chien-An Chen, Taipei (TW); Wen-Jui Chuang, Banciao (TW)

Correspondence Address: G. LINK CO., LTD., 3550 BELL ROAD, MINOOKA, IL, 60447, US

(21) Appl. No.: 11/754,378

(22) Filed: May 29, 2007

(30) Foreign Application Priority Data
Jun. 1, 2006 (TW) 095209469

(51) Int. Cl. F16K 17/02; F16K 15/14

(52) U.S. Cl. 137/849

(57) ABSTRACT

The present invention is a pressure relief valve structure with pressure relief seam, which is composed of the pipe, and the elastic plug with the edge tightly attached on the pipe wall of the pipe, and the elastic plug is penetrated with slim seam. When the fluid is flowing to the elastic plug through the pipe, and the impact pressure from the fluid is larger than the slim seam of the elastic plug could resist, the intersection along the slim seam would be deformed as a hole to make the fluid flowing through the elastic plug and achieve the purpose of pressure relief.

### FIELD OF THE INVENTION

The present invention relates to a pressure relief valve structure, and particularly to a pressure relief structure with pressure relief seam.

### BACKGROUND OF THE INVENTION

Currently, only thermal power, water power and nuclear power could be produced in an industrial scale. The power generation using fuel cell named as the fourth electricity has been rapidly applied in the fully developed countries, such as the United States, and Japan, and is rapidly entering the group of power generation in industrial scale with a fast catching up trend.

The fuel cell is a battery converting chemical energy into electric energy, and it employs the energy released from the substance during chemical reaction, and directly transfers into electric energy. Comparing to other chemical batteries, such as Mn dry battery and Pb secondary cell, the fuel cell is required to continuously supply the active substance, i.e. the reactant, such as fuel and oxidant, during operation, so that the fuel cell is different from the other ordinary chemical batteries.

As for the direct methanol fuel cell, the fluid, such as methanol aqueous solution and air, will flow inside the direct methanol fuel cell; at the same time, the fluid product, such as carbon dioxide and water, from the direct methanol fuel cell after electrochemical reaction will flow outwardly inside the direct methanol fuel cell. Thus, if the inner pressure of the direct methanol fuel cell is exceptionally too large, the fluid will generate the unexpected flowing effect. Therefore, if the direct methanol fuel cell is not configured with pressure relief mechanism, it will easily cause the damage of the direct methanol fuel cell.

Please refer to FIGS. 1A and 1B. FIGS. 1A and 1B is a diagram for the conventional pressure relief valve structure. As shown in FIGS. 1A and 1B, it shows the prior arts of a regulation structure for air pressure. As shown in FIG. 1A, if the high pressure gas is entered from the inlet, the resulted impact force will push the roller 3. As shown in FIG. 1B, if the impact force is larger than the elastic device 41 against the roller 3, the roller 3 originally blocking the inlet portion 200 will no longer block the inlet, and the high pressure gas would flow to the gas leakage portion 22 along the arrow direction 5 to exhaust the high pressure gas.

However, the elastic device 41 of the above said prior arts is made of metal, so if it is directly applied for the pressure relief function of fuel cell, the elastic device 41 will be easily eroded after long time usage, and the elastic device 41 will lose the original function against the roller 3, and further make the whole pressure relief valve dysfunctional.

### SUMMARY OF THE INVENTION

The main object of the present invention is to provide a pressure relief valve structure with pressure relief seam, in which, for the seam configured on the elastic plug, when the pressure is larger than the material property, the seam will become a hole, and further exhaust the high pressure fluid.

To this end, the present invention provides a pressure relief valve structure with pressure relief seam, which is composed of the pipe, and the elastic plug with the edge tightly attached on the pipe wall of the pipe, and the elastic plug is penetrated with slim seam. When the fluid is flowing to the elastic plug through the pipe, and the impact pressure from the fluid is larger than the slim seam of the elastic plug could resist, the intersection along the slim seam would be deformed as a hole to make the fluid flowing through the elastic plug and achieve the purpose of pressure relief.

### BRIEF DESCRIPTION OF THE DRAWINGS

The present invention would be detailed described in the following to make the skilled in the art further understand the advantages and spirit of the present invention with the attached figures wherein:

FIGS. 1A and 1B are the diagrams of the conventional pressure relief valve structure;

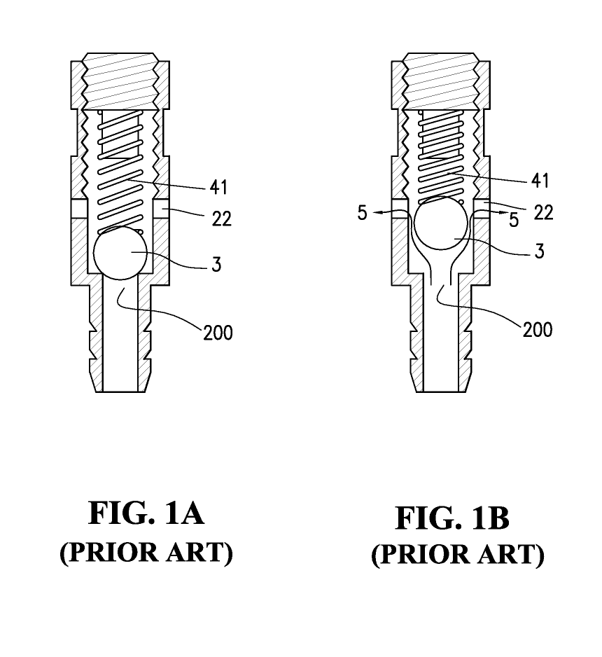

FIGS. 2A and 2B are the diagrams without pressure relief for the pressure relief valve structure with pressure relief seam according to the present invention; and

FIGS. 3A and 3B are the pressure relief diagrams for the pressure relief valve structure with pressure relief seam according to the present invention.

### DETAILED DESCRIPTION OF THE INVENTION

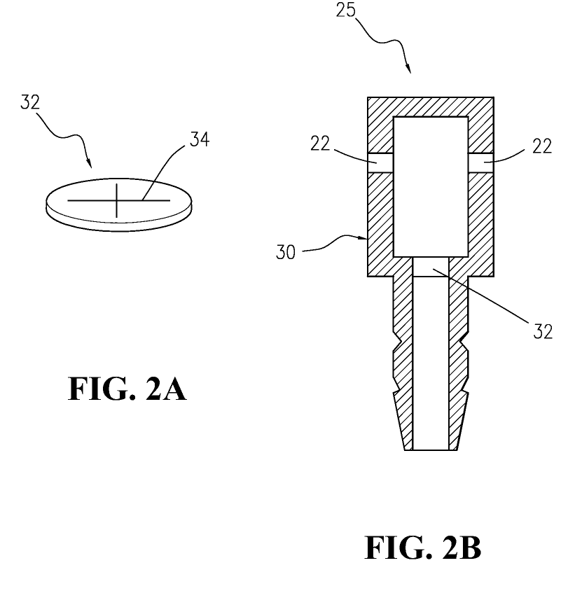

FIGS. 2A and 2B are the diagrams without pressure relief for the pressure relief valve structure with pressure relief seam according to the present invention. As shown in FIGS. 2A and 2B, the pressure relief valve structure with pressure relief seam 25 according to the present invention is composed of a pipe 30, an elastic plug 32, and a pressure relief seam 34 penetrated on the elastic plug 32. The pipe 30 as shown in FIG. 2B is only an example, but not limiting the spirit of the present invention only using this shape of pipe 30.

In the pressure relief valve structure with pressure relief seam 25 according to the present invention, the elastic plug 32 made of elastic material has its edge completely and tightly attached on the pipe wall of the pipe 30. In order to form the pressure relief seam 34, it could be formed by using sharp knife cutting through elastic plug 32 according to the predetermined diagram. However, the pattern for the seam 34 could not only be the cross shown in FIG. 2A, but also be trident, “*”, or other types of seams.

The material selected for the elastic plug 32 could be silica gel or latex material, so even the elastic plug 32 is penetrated, due to the elastic property of the material itself, when there is not sufficient external force or action force, the fluid in the pipe 30 will still not flow to the gas leakage portion 22 through the pressure relief seam of the elastic plug 32.

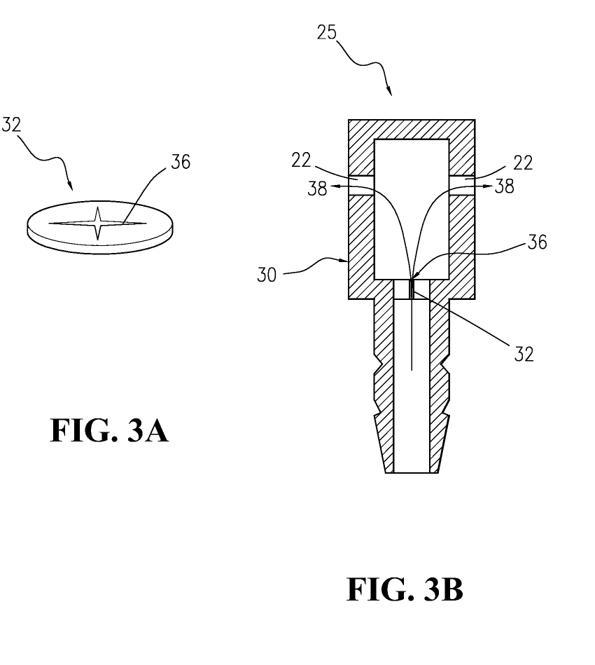

Please refer to FIGS. 3A and 3B. FIGS. 3A and 3B are the pressure relief diagrams for the pressure relief valve structure with pressure relief seam according to the present invention. As shown in FIGS. 3A and 3B, the pressure relief valve structure with pressure relief seam 25 according to the present invention is still composed of a pipe 30 and an elastic plug 32, but only formed with a hole 36 caused by the impact pressure from the fluid.

Specifically, when the fluid is flowing to the elastic plug 32 through the pipe 30, and the impact pressure caused by the fluid is larger than the seam 34 of the elastic plug 32 could resist, the intersection along the seam 34 would be deformed as a hole 36 to make the fluid flowing through the elastic plug 32 and flowing to the gas leakage portion 22 along the arrow direction 38.

If the fluid would not flow to the elastic plug 32 through the pipe 32, the hole 36, as shown in FIG. 3A, would recover to the seam 34 as shown in FIG. 2A, and make the fluid not flowing through the elastic plug 32.

In a summary, for the pressure relief valve structure with pressure relief seam 25 according to the present invention, only when exceeding the impact pressure which the elastic plug 32 could resist, it would become a hole 36, and let the fluid flow through to achieve the purpose of pressure relief; and, employing the property that the material of the elastic plug 32 itself could be elastically recovered to not let the fluid flow through under normal condition.

The pressure relief valve structure 25 according to the present invention is especially suitable for fuel cell. Due to the structure issue of the pressure relief valve structure 25, it could realize the compact or micro pressure relief valve, which could provide an obvious contribution of realizing the fuel cell as compact or micro fuel cell, and become the advantages and improvement effect of the present invention.

The features and spirit of the present invention have been described in details with the preferred embodiments as above to be clearer, and these disclosed embodiments are not used to limit the scope of the present invention. On the opposite, the object of this disclosure is to include all kinds of changes and equivalent arrangement within the scope of the claimed applied by the present invention.

What is claimed is:

1. A pressure relief structure with pressure relief seam, which is provided to a fuel cell for pressure relief, in which the pressure relief valve structure comprises:
a pipe;
an elastic plug, which is made of elastic material, and has the edge completely and tightly attached on the pipe wall of the pipe; and
a seam, which is penetrated on the elastic plug.

2. The pressure relief valve structure with pressure relief seam according to claim 1, wherein the pressure relief seam has been patternized as trident, cross, “*”, or other types of seams.

3. The pressure relief valve structure with pressure relief seam according to claim 1, wherein the material of the elastic plug could be silica gel or latex material.

4. The pressure relief valve structure with pressure relief seam according to claim 1, wherein when a fluid is flowing to the elastic plug through the pipe, and the impact pressure caused by the fluid is larger than the seam of the elastic plug could resist, the intersection along the seam could be deformed as a hole to make the fluid flowing through the elastic plug.

5. The pressure relief valve structure with pressure relief seam according to claim 4, wherein when the fluid is not flowing to the elastic plug through the pipe, the hole could be recovered to the seam to not make the fluid flowing through the elastic plug.
